(19) United States
(12) Patent Application Publication
(10) Pub. No.: US 2011/0075903 A1
(43) Pub. Date: Mar. 31, 2011

(54) METHOD AND SYSTEM FOR THE ANALYSIS OF PECULIARITIES IN FINGERPRINTS

(75) Inventor: Antonio María Turiel Martínez, Barcelona (ES)

(73) Assignee: Consejo Superior De Investigaciones Cientificas, Madrid (ES)

(21) Appl. No.: 12/739,792

(22) PCT Filed: Oct. 24, 2008
(86) PCT No.: PCT/ES2008/070195

§ 371 Date: May 13, 2010

(30) Foreign Application Priority Data
Oct. 26, 2007 (ES) P200702829

(51) Int. Cl. G06K 9/00

(52) U.S. Cl. 382/131; 382/100

(57) ABSTRACT

The proposed method comprises determining for each point of the signal an environment comprising the first neighbours and calculating for each point of the signal a reconstructibility measurement, or singularity measurement, weighting the contributions of said local environment of the point. The value of the signal at each point is inferred from the values of the signal at the points of the local environment using a reconstruction formula. The singularity measurement includes the difference between the value of the signal at the point and the value estimated by its local environment. A logarithmic transformation is carried out on said singularity measurement with a view to obtaining an independent measurement of the amplitude of the sampled digital signal that varies in a controlled manner under changes in resolution.

A system is proposed with means for obtaining said singularity measurement for each point and for carrying out the abovementioned logarithmic transformation and other calculations.

### FIELD OF THE INVENTION

This invention relates to the analysis of digital signals, in other words, signals that are sampled at regular intervals, applying wavelet analysis for implementation of the proposed method, which makes it possible to identify various subsets of particular points in space to a scale and position that is more informative about the signal than others.

The invention likewise relates to a system for the implementation of the proposed method.

Throughout this description a digital signal shall be understood as any structured collection of data uniformly sampled that may be represented by means of a multidimensional matrix whose positions are referred to as signal points.

The invention provides useful techniques and tools for processing, reconstructing and compressing digital signals based on partial information regarding their gradient and in particular operating on the basis of gradient-based measurements obtained through finite increases. Said techniques and tools can be implemented by means of automatic algorithms materialised advantageously in computer programs that can be run in computational environments.

The invention, given the great efficiency that it provides mainly in digital signal reconstruction tasks, in particular those representing images, is applicable in numerous fields, among which as specific applications one could mention digital signal compression (including image compression) and the evaluation of flow lines in fluid-related signals (including determination of current lines in images representing physical phenomena); and as more general applications, the detection of structures and recognition of patterns in images of real environments, such as photographic, geophysical, biomedical and other types of images.

The invention concerns signals defined in any number of dimensions, although once the method has been described for a certain number of dimensions (for example, two), it will be fairly obvious for an expert in the art to generalise it to signals defined in any number of dimensions. For this reason, and for the purposes of simplicity, many of the equations and derivatives presented throughout this description have been written for 2D, in other words two-dimensional signals, likely to constitute elements such as images. However, useful results have also been obtained in other numbers of dimensions and in particular in the processing of 1D signals, such as the stock market time series (see references [16], [17]).

### BACKGROUND OF THE INVENTION

U.S. Pat. No. 5,901,249, U.S. Pat. No. 6,141,452 and U.S. Pat. No. 6,865,291 relate to digital signal compression techniques using wavelet analysis.

U.S. Pat. No. 6,434,261 describes a method for the detection and segmentation of digital images in order to locate targets in said images based on determination of an adaptive threshold to carry out a wavelet analysis of the digital images that are decomposed into different scale channels.

U.S. Pat. No. 7,181,056 concerns a method for the automatic detection of regions of interest in a digital image representing at least one portion of biological tissue, wherein a wavelet-based representation is generated of the regions to be explored.

U.S. Pat. No. 7,062,085 relates to a method for detecting aspects in regions of colour images where reference is made to texture characteristics materialised through coefficients derived from a wavelet transform based on a multiresolution analysis of the colour digital image.

Patent application US-A-2005/0259889 relates to a method for denoising an X-ray image comprising the application of a complex wavelet transform to the image bearing the motif, operating with wavelet coefficients in order to reduce the noise.

Patent application WO-A-2004/068410 concerns a method for detecting points of interest in a digital image which implements a wavelet transform, by associating a subsampled image with an original image.

The analysis of singularity (see reference [14]) which implements the concept of describing the local behaviour of a function f(x) estimated in R^{m} and defined over R^{d} around each of its domain points x in accordance with the so-called Hölder singularity exponent, or Hurst exponent, denoted by h(x), is very useful for many signal processing tasks, and in particular, is very relevant for compression purposes and as a pattern recognition tool, and, depending on the context, can also be used to reveal information regarding the evolution and dynamic of complex signals.

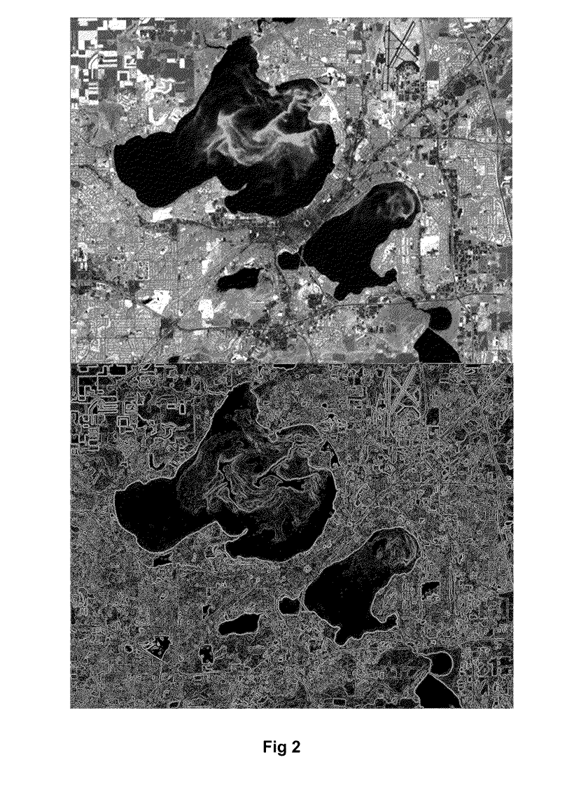

U.S. Pat. No. 6,745,129 concerns a method based on wavelets for the analysis of singularities in seismic data based on the processing of a representative time series of a record of the phenomenon. The object of this patent is to calculate the Hölder exponent over seismic records through a continuous wavelet transform. Using this method, when the signal is analysed (as shown in said patent's FIG. 2b), instabilities occur that affect both spatial resolution as well as the quality of determination of the Hölder exponent for each point (see discussion of this issue in reference [11]). This problem in fact makes it impossible to use the method of U.S. Pat. No. 6,745,129 for tasks of digital signal reconstruction, unlike the proposals of the method of this invention. This invention provides a more accurate determination of the singularity exponents, both in terms of their position, as well as their value. The difference in accuracy between this invention and U.S. Pat. No. 6,745,129 is due to the use of gradient measurements (which eliminates the undesirable fluctuations associated to complex wavelets, see reference [17]) and also because said measurement incorporates an indicator of the degree of reconstructibility. In accordance with the above, this invention also makes it possible to reconstruct a high quality signal based on partial information, unlike the method of U.S. Pat. No. 6,745,129 (see reference [11]).

Within the field of wavelet based signal analysis, applied in particular to digital signal processing one of the most commonly used methods is the so-called Wavelet Transform Modulus Maxima (known as WTMM) which is determined by the local maxima of the wavelet projections. Mallat and Zhong (see references [4], [5] and [6]) surmised that this set can be used to reconstruct the signal completely. Subsequently it has been verified that the set leads to an attenuated signal and that various empirical coefficients have to be introduced in order to be able to reproduce the correct signal amplitudes. Ever since publication of the document by Mallat and Zhong, there have been several attempts to obtain high quality reconstruction based on WTMM. In any case, what is most interesting about the WTMM method is that in the case of images the highest quantity of lines is concentrated around the borders and contours; and since it has been known for years (see reference [7]) that borders and contours contain most of the information about a visual scene, WTMM has proven itself to be a good candidate for extracting perceptual information (borders) using an automatic canonical algorithm based on said method.

Another branch of research also focused on the use of WTMM was initiated by Arneodo and collaborators (see references [1] and [2]) who recognised the capacity of WTMM to deal with multiscale signals, centering their studies on systems known to present scale invariance properties, such as turbulent flows and chaotic systems.

The main inconvenience of all WTMM-based proposals is the impossibility to systematically extract the maxima when these accumulate (topologically), a situation that occurs whenever dealing with real signals, as discussed in [17]. In [10] the problem was studied and partial solutions were proposed.

Aside from the use of WTMM, this field of the technique is aware of recent research by this inventor, A. Turiel, regarding the analysis of singularities based on gradient measurements. In these works, a gradient measurement μ associated to a signal s(x) over an arbitrary set A is defined as the integral of the gradient module over that set:

μ( [symbol] )= [symbol] dx|∇s|(x) (1)

This research by A. Turiel shows that when working with real data, discretised and with noise, it is necessary to operate with wavelet transforms of the measurements in the following manner: given a wavelet Ψ, the wavelet transform of gradient measurement μ at a scale r and at a point x is given by the expression:

$${T}_{Ψ} μ ( x , r ) ≡ \int d μ ( {x}^{′} ) \frac{1}{{r}^{d}} Ψ ( \frac{x - {x}^{′}}{r} ) \qquad ( 2 )$$

where d is the signal dimension.

The wavelet transform of measure μ makes it possible to determine the local singularity exponent, since the dominant term when r is small depends on r as a power law (see reference [14])

T_{Ψ}μ(x,r)=α_{Ψ}(x)r^{h(x)}+o(r^{h(x)}) (3)

By introducing gradient measurements it is possible to improve the spatial resolution of the singularity exponents (see references [11] and [14]). In this way, instead of having a singularity exponent every ten pixels or requiring control of oscillations due to the wavelet, it is possible to assign a singularity exponent to every pixel with a minimum dispersion of the point. It is appreciated that there are differences in the resolution capacities of the different wavelets, meaning that the need to find an optimised wavelet suitable for dealing with discretised data has been recognised.

An important element in the construction of wavelets with a capacity for optimised resolution is the concept of reconstructing signals using partial information regarding their gradient. The theoretical approaches and practical implementations of a gradient reconstruction algorithm appear in reference [12], which introduces a discussion regarding the structure of multifractal signals (see references [8], [3] on the multifractal structure of turbulent fluids). For signals with a multifractal structure, the set associated to the upper vertex of the hierarchy is well known, at least from a theoretical point of view, and is known as the Most Singular Manifold (MSM), which is the set comprising the points with the most singular (in other words, most negative) values of h(x).

Reference [12] mentioned above maintains the theory that MSM contains sufficient information to reconstruct the signal completely, analysing the reconstruction of images although the formulae are valid for any number of dimensions. The reconstruction formula obtained in [12] for infinitely large domains is as follows:

s(x)=(\vec{g}· [symbol] )(x) (4)

where:
s is a given signal,
[symbol] is the most singular manifold or MSM of said signal s
[symbol] (x)=( [symbol] , [symbol] )(x)) is the essential gradient vector of s, in other words, the gradient restricted to the MSM, whose components are [symbol] (x)=∂ₓs(x) si x∈ [symbol] , [symbol] (x)=0 si x∉ [symbol] [symbol] (x)=∂_{y}s(x) si x∈ [symbol] , [symbol] (x)=0 si x∉ [symbol] ,
\vec{g}(x)=gₓ(x),g_{y}(x)) is the vectorial kernel of universal reconstruction, which in the Fourier space is given by the expression:

$$\hat{\overline{g}} ( k ) = i \frac{k}{{k}^{2}}$$

and
notation • means the convolution scalar product, in other words, (\vec{g}· [symbol] )(x)=(gₓ* [symbol] )(x)+(g_{y}* [symbol] )(x), where * means the ordinary convolution product of functions.

From the studies carried out by this inventor (see reference [12]) taking gradient measurements into consideration, it has been concluded that, if one exists, there is only one possible algorithm for reconstructing signals using the gradient based on MSM in infinitely large domains. Likewise, it is known that MSM leads to very good reconstructions with this algorithm (see references [11] and [12] for images, and [15], [16] for time series).

### BRIEF DESCRIPTION OF THE INVENTION

This invention proposes a method for the analysis of singularities in digital signals, which comprises

a) determining a first-neighbour environment for each point of the signal; and

b) calculating for each point of the signal x a reconstructibility or reconstruction capacity measurement provided by the environment (which we will refer to, indiscriminately, as “singularity measurement”) based on the abovementioned environment, constructed from inference of the signal's value at x according to the value of the signal at the points of said environment of x using the reconstruction function explained in reference [12] and indicated in formula (4) above, but adapted to the environment, in such a way that a singularity measurement is obtained that contains the difference between the measured value of the point and the value inferred from its environment.

The proposed method also comprises advantageously a third stage c) wherein at least one logarithmic transformation is carried out on said reconstructibility measurement which suppresses the measurement's dependence on the total number of points of the signal, thus obtaining a singularity exponent for each point of the signal.

In an improved embodiment, the proposed method comprises the following stages:

a1) obtaining a stable derivative function of a digital signal, which is sampled at regular intervals;

b1) obtaining for each point of said digital signal, a singularity measurement of the function at that point, weighting the contributions of a local environment of the point (using a reconstruction function as indicated previously) and the value of the derivative at all points of said local environment, and

c1) carrying out at least one logarithmic transformation on said singularity measurement with a view to obtaining an independent measurement of the amplitude of the sampled digital signal and that varies in a controlled manner under changes in resolution.

The invention also comprises the generalisation of the singularity measurement as described under the preceding background heading, by proposing a new singularity measurement based on the set or manifold of unpredictable points, UPM in its English acronym; in other words, one starts out by considering the grouping of all unpredictable points, as against the other points that are predictable.

### DETAILED DESCRIPTION OF THE INVENTION

The object of this invention, as indicated in the previous section, comprises the calculation of a reconstructibility measurement in order to calculate accurately the singularity exponents of a digital signal, and for said exponents to enable obtaining high quality reconstructions. The basic requirements for defining a singularity measurement μ based on the unpredictable points manifold UPM are as follows:
i) Measurement μ must refer to the local singular behaviour of the functions.
ii) Measurement μ must lead to a more singular manifold MSM as close to the unpredictable points manifold UPM as possible.

The measurements of the unpredictable points manifold are singularity measurements that also take into account the level of predictability of the points according to the equation

div( [symbol] )=0 (5)

where F is the UPM and the superscript “c” denotes the complementary set, in other words, the predictable points; this equation (5) is a consequence of equation (4) as described in [12]. Therefore, equation (5) shows that the divergence of the gradient taken only over the predictable points is cancelled out.

The inventor proposes herein that the best way of continuing to work with singularities is to define the measurements based on the set of unpredictable points as wavelet projections of standard gradient measurements. In this way, the measurement of the set of unpredictable points is a wavelet projection of the gradient measurement expressly designed to penalise unpredictability. This entails generalising the concept of wavelet projection, with a view to producing wavelet projections with vectorial values. The use of wavelet projections with vectorial values has been well known for some time and does not introduce special complexities into the way of approaching the problem.

Another main difference in relation to the standard singularity analysis described in the abovementioned background is that the proposal of this invention does not carry out wavelet projections of the singularity measurement on various scales r in order to extract the singularity exponents by means of a logarithmic regression applied to the equation (3).

T_{Ψ}μ(x,r)=α_{Ψ}(x)r^{h(x)}+o(r^{h(x)}) (6)

One must highlight that projecting the measurement on a wavelet at various scales is costly in computation time and only serves to improve the resolution of less singular structures at the expense of worsening the more singular ones (see the arguments in this respect in reference [17]). Given that the fundamental objective in relation to this invention is to extract the most singular structures, it is detrimental to carry out the projections across multiple scales; instead, the proposal is to use a point estimator (see references [17], [9] of the singularity exponents, namely:

$$h ( x ) = \frac{log ( {T}_{Ψ} μ ( x , {r}_{0} ) / \{ {T}_{Ψ} μ ( {}^{.} , {r}_{0} ) \} )}{log {r}_{0}} + o ( \frac{1}{log {r}_{0}} ) \qquad ( 7 )$$

where {T_{Ψ}μ(•,(r₀)} is the wavelet projection measurement across the entire signal and serves to decrease the relative amplitude of the correction o(1/log r₀). In applying the equation (7), r₀ must be sufficiently small to disregard this correction. The scale r₀ is defined as the least accessible, in other words, the scale of one pixel. Conventionally a Lebesgue measurement of 1 is applied to the entire spatial domain, meaning that, in the case of an image of N×M pixels, the value of r₀ would be set at:

$${r}_{0} = \frac{1}{\sqrt{NM}} \qquad ( 8 )$$

thus, in general, sufficiently large images are required to make the first term on the right hand side of the equation (7) a good approximation to the singularity exponent. This typically implies having images of at least 100 pixels in one of the directions.

An important aspect of this invention lies in the design of digital wavelets in order to implement singularity measurements based on unpredictable points manifold. Below two implementations of measurements based on unpredictable points manifold of this type are presented, which provide a good result in practical applications. The design is oriented, overall, at the processing of digital signals and, consequently, the wavelets are defined (implicitly) by means of numerical weights, although the presentation is based on a theory and is easy to generalise to a continuous scheme.

Another important element of the proposed method lies in the way of defining and/or establishing numerical estimations of the gradient ∇s so that the reconstruction is numerically stable. To do this, two possible options are suggested: differences of one pixel or point to the right and differences of half a pixel, in other words, the differences in value when moving one position to the right in the first instance, or the interpolation equivalent to the difference that would be obtained by moving half a position to the right and to the left of the point in the second instance. Both are defined by the derivative cores described in the Fourier space.

In other words, the stable derivative of stage a1) of the method, mentioned above, is obtained derived from increases to the right of one point or centred of half a point.

In the formulae that follow, ∂ₓ will be characterised, although the characterisation of ∂_{y} is analogous. This operator acts on a digital signal by simply multiplying the signal's Fourier transform by the derivative cores, and then anti-transforming the result. It is assumed that there are Nₓ pixels or points in direction x and N_{y} in direction y.

Difference of one pixel/point to the right:

$${( {{\partial }^{⋒}}_{x} )}_{n} = ( {e}^{2 π i \frac{n}{{N}_{x}}} - 1 ) \qquad ( 9 )$$

Difference of half a pixel/point:

$${( {{\partial }^{⋒}}_{x} )}_{n} = \{ \begin{matrix}i sin ( π \frac{n}{{N}_{x}} ) ; & n < {N}_{x} / 2 \\ - i sin ( π \frac{{N}_{x} - n}{{N}_{x}} ) ; & n \geq {N}_{x} / 2\end{matrix} \qquad ( 10 )$$

Another basic aspect of the proposed method consists of introducing the new concept of the cross Fourier transform. In order to estimate the level of predictability of a given point, a reconstruction formula is applied, which is expressed by the following equation

s(x)=(\vec{g}· [symbol] )(x) (11)

for the least possible number of neighbours of a point, specifically its first neighbours. In 2D (where d is the signal dimension; therefore, d=2 in this case) it consists of 4 neighbouring points, which, together with the original point, form a cross. For any quantity p(x) the neighbours of any point x₀ are represented by means of a 5-component vector comprising said point and its four closest neighbours, following the indexation convention indicated in the following drawing, which illustrates in schematic outline the indexation of the points of the cross in 2D. In this way, the central point will be assigned index 0, the point to its right index 1, the point to its left index 2, the point above index 3 and the point below index 4. Thus, the first neighbour environment of the point under study becomes vector (p₀, p₁, p₂, p₃, p₄).

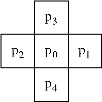

In other words, in respect of the centre of the cross, the position of all other points corresponds to shifts of ±1 (in units of one point) either in direction x or in direction y. In order to define a Fourier transform specialised or adapted to this cross configuration, one must taken into account that the basic Nyquist frequency in each direction is 2π/3. In order to simplify the notation, the basic complex element ζ is introduced:

ζ=ζ_{R}+iζ_{I}=e^{2πi/3}=cos(2π/3)+i sin(2π/3) (12)

According to the invention, the direct cross Fourier transform of any 5-component vector \vec{p}=(p₀, p₁, p₂, p₃, p₄) is defined as the complex T-component vector {right arrow over (\hat{p}=(\hat{p}₀, \hat{p}₁, \hat{p}₂, \hat{p}₃, \hat{p}₄) obtained from the following formula:

{right arrow over (\hat{p}=F\vec{p} (13)

where F is the following complex matrix of 5×5:

$$F = \frac{1}{3} ( \begin{matrix}1 & 1 & 1 & 1 & 1 \\ 1 & ζ & {ζ}^{*} & 1 & 1 \\ 1 & {ζ}^{*} & ζ & 1 & 1 \\ 1 & 1 & 1 & ζ & {ζ}^{*} \\ 1 & 1 & 1 & {ζ}^{*} & ζ\end{matrix} ) \qquad ( 14 )$$

This matrix represents the linear combination of the harmonics associated to the shifts in the cross and is designed to represent as faithfully as possible the composition in the centre of the cross, based on the nearest points. The inverse of this matrix can be easily calculated,

$${F}^{- 1} = ( \begin{matrix}- 1 & 1 & 1 & 1 & 1 \\ 1 & {ζ}^{*} & ζ & 0 & 0 \\ 1 & ζ & {ζ}^{*} & 0 & 0 \\ 1 & 0 & 0 & {ζ}^{*} & ζ \\ 1 & 0 & 0 & ζ & {ζ}^{*}\end{matrix} ) \qquad ( 15 )$$

and this last matrix is necessary in order to carry out the anti-cross Fourier transform.

It is necessary to define implementations of the gradient and the reconstruction formula restricted to the cross, in order to rapidly evaluate the level of predictability of the central point according to its neighbours. For this reason, this invention proposes suitable implementations of the gradient and of the reconstruction formula of said gradient, on the basis of the cross Fourier transform.

A first implementation is that of the cross gradient operator in local gradient operator functions, which is operator (∂ₓ,∂_{y})=F⁻¹·(\hat{∂}ₓ,\hat{∂}_{y})·F. In the Fourier space, said operator acts simply by multiplying any function by functions \hat{∂}ₓ and \hat{∂}_{y} in order to obtain coordinates x and y, respectively. Function \hat{∂}ₓ is defined for cross environments as follows:

\hat{∂}ₓ=(0,i\sqrt{3},−i\sqrt{3},0,0) (16)

and, similarly, we have:

\hat{∂}_{y}=(0,0,0,i\sqrt{3},−i\sqrt{3}) (17)

which are defined in such a way as to represent differences of half a pixel; in fact \sqrt{3}=2 sin(π/3).

A second implementation is that of the cross reconstruction operator, which is one of the inverses of the cross gradient operator. Since the gradient operator eliminates any constant added to each component of the 5-component vector representing the neighbours, the reconstruction is fully defined except by a change in that constant; our proposed implementation of the cross reconstruction operator is such that the resulting 5-component vector has a zero mean, Σᵢ₌₀⁴pᵢ=0. For this reason, the signals must have the mean subtracted before applying these two operators. To this effect the elements of the matrix of the first line of the Fourier transform are applied in inverse cross so as not to introduce harmonics when the reconstruction operator is applied. Since the sum of the elements of that first line is (2×d)−1 (whose result is 3 in the case of 2D signals), in order to subtract the mean all the values of the environment vector (first neighbours) are added up and divided by ((2×d)−1), adding to the result the first component of the environment vector and subtracting the other components.

The cross reconstruction is the operator R=F⁻¹·\hat{R}·F. In the Fourier space \hat{R} has two functional components, \hat{R}=(\hat{R}ₓ,\hat{R}_{y}); the operator acts as the sum of the product of each component with the corresponding component (x and y) of the gradient on which it operates. The component \hat{R}ₓ is defined for a cross environment as follows:

\hat{R}ₓ=(0,−i/\sqrt{3},i/\sqrt{3},0,0) (18)

and, similarly for \hat{R}_{y},

\hat{R}_{y}=(0,0,0,−i/\sqrt{3},i/\sqrt{3}) (19)

In this way, the singularity measurement defined in stage b1) of the method of this invention can be described by means of the following steps for a generic signal defined in a space of arbitrary dimension d:
the environment of the (2×d) first neighbours of a base point x is extracted, obtaining the first neighbours of point x, consecutively modifying each one and only one of the coordinate indices of said point x, first by adding −1 and then by adding +1, forming a vector of (2×d)+1 components, whose first component is the value of the signal at point x, the second the value of the signal at the point obtained by modifying the first coordinate through adding −1, the third the value of the signal at the point obtained by modifying the first coordinate through adding +1, the fourth the value of the signal at the point obtained by modifying the second coordinate through adding −1 and so on successively;
the tendency of this vector is extracted, which is defined as the sum of its values divided by ((2×d)−1) and this tendency is applied to the vector, adding it to the component referring to base point x and subtracting it from the other components, so that in this way the new vector obtained has zero mean;
a local gradient operator is applied to the abovementioned zero mean vector, which returns (2×d)+1 gradient vectors each one of them of d components, which define the local gradient:
the components of said local gradient associated to point x are cancelled out;
the local gradient, with the cancelled out components, is applied a reconstruction operator associated unequivocally to the abovementioned local gradient operator obtaining a vector of (2×d)+1 components, referred to as estimated signal;
once more the local gradient operator is applied to said vector of (2×d)+1 components or estimated signal and (2×d)+1 vectors of d components are obtained, which define the estimated local gradient; −(2×d)+1 vectors of d components are obtained, which express the difference in gradients between said local gradient and said estimated local gradient, and from these (2×d)+1 vectors of difference in gradient the singularity measurement associated to point x is obtained.

The cross gradient and cross reconstruction operators are two of the procedures included in this invention capable of implementation by means of basic algorithms materialised advantageously in computer programs that can be run in a computational environment, for the design and calculation of singularity measurements based on unpredictable point manifolds. In particular such programs or parts thereof may be included in routines stored in microprocessors or microchips. These operators can be simplified to a matrix form of ((2×d)+1)×((2×d)+1), for faster numerical implementation.

Below two singularity measurements are described designed in accordance with the principles of this invention:
local correlation singularity measurement (lcsm); and
global correlation singularity measurement (gcsm)

Both measurements can be implemented by means of specific algorithms materialised advantageously in computer programs that can be run in a computational environment. In particular such programs or parts thereof may be included in routines stored in microprocessors or microchips.

The local correlation singularity measurement has been conceived in order to measure the unpredictability of a given point, simply by calculating the difference between the real value of the signal without mean (in other words, once the mean has been eliminated) at a given point and the value inferred on the basis of its four neighbours (when d=2). The purpose of this measurement is to evaluate T_{Ψ}_{_{lcsm}}μ(x₀,r₀) at a given point x₀ and in the case d=2 comprises the following steps:
1. The neighbours of x₀ are converted into a 5-component vector \vec{s}=(s₀, s₁, s₂, s₃, s₄) following the cross indexation scheme of the drawing shown above.
2. The vector is appropriately rectified: in the first instance obtaining

$$\overline{S} = \frac{1}{3} {\sum }_{i = 1}^{5} {s}_{i} ,$$

and the rectified vector, \vec{p}=(p₀, p₁, p₂, p₃, p₄), is defined as:

p₀=s₀+ S̅

pᵢ=s₀− S̅, i=1, . . . , 4 (20)
3. The cross gradient operator is applied to \vec{p} in order to obtain vectors \vec{g}ₓ and \vec{g}_{y}.
4. The value of the components associated to index 0 of said vectors is preserved for subsequent use, Aₓ=g_{x,0}, A_{y}=g_{y,0}.
5. Said two components are adjusted to zero, g_{x,0}=g_{y,0}=0.
6. The cross reconstruction operator is applied to the resulting vectors \vec{g}ₓ and \vec{g}_{y}, in order to obtain the reconstructed signal \vec{r}.
7. The cross gradient operator is applied once more to \vec{r} in order to obtain the estimated gradients, \vec{ρ}ₓ and \vec{ρ}_{y}.
8. The local correlation singularity measurement is defined as the module of the difference of the cross gradients in the centre of said cross, namely:

T_{Ψ}_{_{lcsm}}μ(x₀,r₀)=\sqrt{(Aₓ−ρ_{x,0})²+(A_{y}−ρ_{y,0})²} (21)
In fact, this last step means preserving the module of a wavelet projection with vectorial values, but in order to simplify the notation it is left as is.
9. Next the singularity exponent h(x₀) is obtained by applying equation (7).

In other words, the singularity measurement associated to point x comprises:
withholding from the obtained (2×d)+1 vectors of local difference in gradient the d components associated to point x, and
obtaining the singularity measurement as the square root of the sum of the squares of these d components
   whereupon a local correlation singularity measurement is obtained suitable for measuring the unpredictability of a given point.

The global correlation singularity measurement improves that of local correlation by taking into account not only the size of deviations between the estimated and real signals, but also the difference between the directions of the obtained gradients. For this reason, the initial data is not only the signal s(\vec{x}), but also the gradient ∇s(\vec{x}). It is very important to provide a stable characterisation of ∇s(\vec{x}); to this effect, the two cores mentioned above have been used: a core of differences of one pixel forward and a core of half pixel increases.

The global correlation singularity measurement has a more complex structure; however, the inventor has verified that it is the most effective for evaluating singularities and at the same time guaranteeing a high quality of reconstruction. Obtaining this measurement is carried out in two stages: in the first place, a gradient difference is obtained for all points; next, the measurement at each point x₀ is constructed by combining the differences in gradient associated to said point and the gradient ∇s in each group of neighbours of said point.

The purpose of this measurement is to evaluate T_{Ψ}_{_{gcsm}}μ(x₀,r₀) at a given point x₀ and comprises the following steps:

First stage: obtaining the differences in gradient at each point x₀.
1. The neighbours of x₀ are converted into a 5-component vector \vec{s}=(s₀, s₁, s₂, s₃, s₄) following the cross indexation scheme of the drawing shown above.
2. The vector is appropriately rectified: in the first instance obtaining

$$\overline{S} = \frac{1}{3} {\sum }_{i = 1}^{5} {s}_{i} ,$$

and the rectified vector, \vec{p}=(p₀, p₁, p₂, p₃, p₄), is defined as:

p₀=s₀+ S̅

pᵢ=s₀− S̅, i=1, . . . , 4 (22)
3. The cross gradient operator is applied to \vec{p} in order to obtain vectors \vec{g}ₓ and \vec{g}_{y}.
4. The value of the components associated to index 0 of said vectors is preserved for subsequent use, Aₓ=g_{x,0}, A_{y}=g_{y,0}.
5. Said two components are adjusted to zero, g_{x,0}=g_{y,0}=0.
6. The cross reconstruction operator is applied to the resulting vectors \vec{g}ₓ and \vec{g}_{y}, in order to obtain the reconstructed signal \vec{r}.
7. The cross gradient operator is applied once more to \vec{r} in order to obtain the estimated gradient vectors \vec{ρ}ₓ and \vec{ρ}_{y}.
8. The difference in gradient associated to the central point is generated, (∈ₓ,∈_{y})=(ρₓ−Aₓ, ρ_{y}−A_{y}).

Second stage: the global correlation singularity measurement is evaluated by combining the differences in gradient and the gradients of the group of neighbours of each point in accordance with the following steps:
1. For each point x₀, the window of 3×3 centred around it is taken into consideration. In this window, each point has coordinates x₀+(dₓ,d_{y}), where dₓ,d_{y} can have the values −1, 0, 1.
2. The autoprojection of the differences in gradients in this window is calculated, S(x₀):

$$S ( {x}_{0} ) = {ɛ}_{x} ( {x}_{0} ) {\sum }_{{d}_{x} , {d}_{y} = - 1 , 0 , 1} {ɛ}_{x} ( {x}_{0} + ( {d}_{x} , {d}_{y} ) ) + {ɛ}_{y} ( {x}_{0} ) {\sum }_{{d}_{x} , {d}_{y} = - 1 , 0 , 1} {ɛ}_{y} ( {x}_{0} + ( {d}_{x} , {d}_{y} ) ) \qquad ( 23 )$$

In other words, the singularity measurement associated to point x comprises:
taking the d-dimensional hypercube that surrounds a given point x, formed by the points obtained when −1, 0 or +1 is added to the coordinate indices, which provides 3^{d} points;
withholding for each point of said hypercube the d dimensional vector, the local difference in gradient of that point, and
   adding these 3^{d} vectors of d dimensions, and calculating the scalar product of the resulting vector with the d dimensional vector of difference in gradient associated to point x, which provides an alignment index of local differences in gradient.
The alignment index of differences in gradient allows us to deduce the existence of a spatial coherence between the errors committed by omitting the central point when the signal is reconstructed, which allows us to differentiate between noise (of random orientation) and coherent signal.
3. The energy of the gradient associated to this window is obtained, E(x₀):

$$E ( {x}_{0} ) = {\sum }_{{d}_{x} , {d}_{y} = - 1 , 0 , 1} ( {\partial }_{x} {s ( {x}_{0} + ( {d}_{x} , {d}_{y} ) )}^{2} + {\partial }_{y} {s ( {x}_{0} + ( {d}_{x} , {d}_{y} ) )}^{2} ) \qquad ( 24 )$$

4. The energy of difference in gradient of point x₀ is obtained, e(x₀):

e(x₀)=∈ₓ(x₀)²+∈_{y}(x₀)² (25)
5. Finally, the global correlation singularity measurement is defined as:

$${T}_{{Ψ}_{gcsm}} μ ( {x}_{0} , {r}_{0} ) = \sqrt{e ( {x}_{0} ) \frac{\vert S ( {x}_{0} ) \vert}{E ( {x}_{0} )}} \qquad ( 26 )$$

In this case, the definition is much more complex and the linearity has been totally lost, even if wavelet projections with vectorial values are considered.
One can see that the gradient energy of said hypercube has been obtained as the sum of the squared modules of the gradients of each point of the hypercube.
On a separate note, one can see that the global singularity measurement is the product of the local correlation singularity measurement obtained as explained above, from the squared root of the absolute value of the alignment index of local differences in gradient divided by the gradient energy of the hypercube.
6. Next the singularity exponent h(x₀) is obtained by applying equation (7).

The invention described hereto can be implemented by means of computation techniques run on operating or calculation units. The implementation of the method comprises a system for the analysis of singularities in digital signals characterised in that it comprises in a basic version:
means for obtaining for each point of the signal a local environment which comprises the first neighbours; and
means for calculating for each point x of the signal a reconstructibility measurement, or singularity measurement, based on the corresponding environment associated to each point, constructed from inference of the value of each point based on the value of the points of said environment using the following function or reconstruction formula for the calculation

s(x)=(\vec{g}· [symbol] )(x)

where
s is a given signal,
[symbol] is the most singular manifold or MSM of said signal s,
[symbol] is the essential gradient of s,
\vec{g} is the universal reconstruction kernel, and
symbol • means the convolution scalar product, said singularity measurement containing the difference between the measured value and the inferred value for each point.

According to an improved embodiment, the system will additionally comprise means for carrying out at least one logarithmic transformation on said reconstructibility measurement designed to suppress the dependency on the number of points of the signal and providing a singularity exponent for each point of the signal and in general:

means for obtaining a stable derivative function of a digital signal, sampled at regular intervals;

means for obtaining for each point of said sampled digital signal a singularity measurement of the function at that point, weighting the contributions of a local environment of the point and the value of the derivative at all points of said local environment; and

means for carrying out at least one logarithmic transformation of said singularity measurement with a view to obtaining an independent measurement of the amplitude of the sampled digital signal and that varies in a controlled manner under changes in resolution.

Said means will comprise in general calculation or data processing units integrated in the system or materialised in the form of an integrated circuit or dedicated processing unit. The instructions for executing the stages of the method will be recorded in programs that can be loaded on the operating units or integrated in electronic circuits.

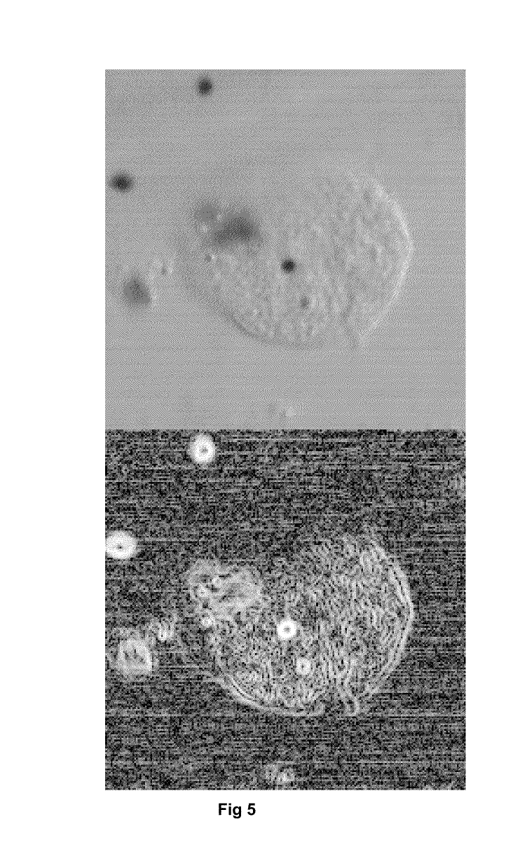

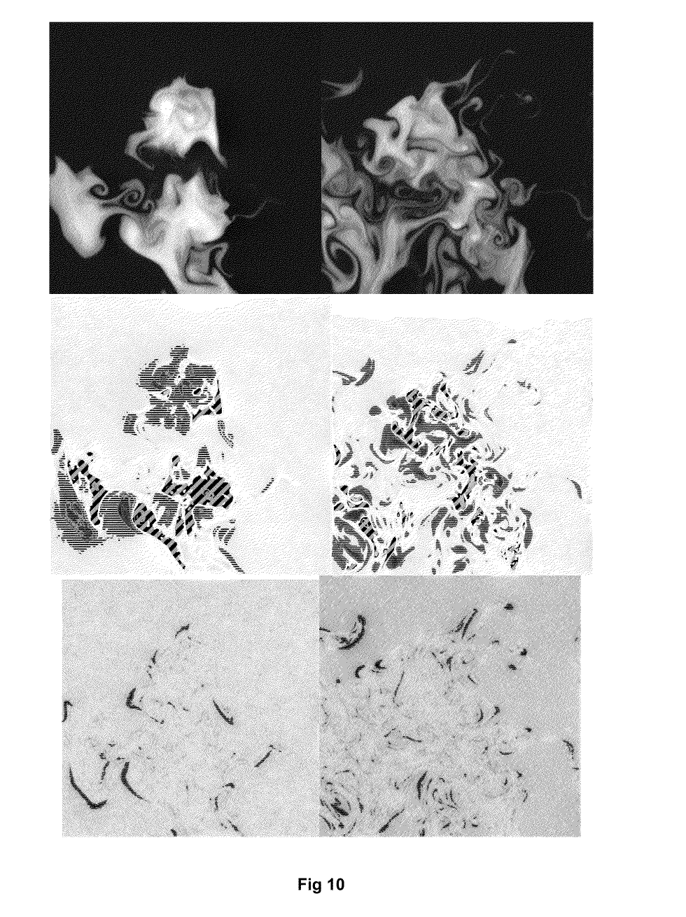

Below several examples are described, to be considered non-limitative of the application of the method in accordance with the invention in different fields. All of the digital signals processed in the following examples have been obtained from public databases, except those corresponding to FIGS. 5 and 10. All signals have been processed using a programme written by the inventor in C language and run on a personal computer with a Linux operating system. The singularity exponents obtained have been converted into digital images by the same program.

### Example 1

### Detection of Structures and Recognition of Patterns

Singularity exponents make it possible to recognise very subtle structures which are difficult to detect at first sight. This is so because the exponents measure the degree of transition of the signal (in other words, their blur) at each point irrespective of their real amplitude. This can be used to detect small modifications in a medium and to prove the existence of new structures in images. The range of applications covers all manner of images, from medical imagery through to remote detection, as well as the detection of manipulated photographs.

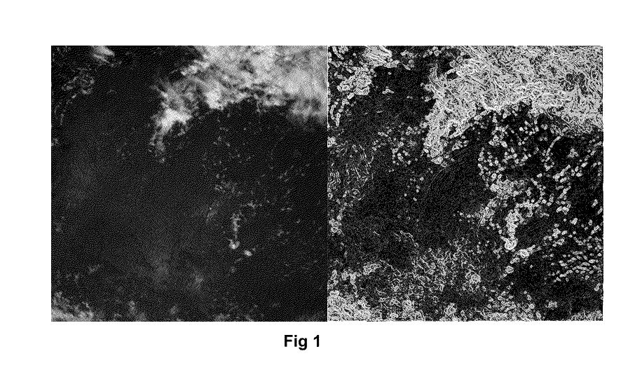

FIG. 1 of the drawings indicates the detection of internal oceanic waves from a MeteoSat satellite image (see reference [14]). The image on the left shows a portion of the visible channel of the MeteoSat V satellite acquired on 27 Dec. 2004 over the submarine Mascarene Ridge (Northeast area of Madagascar); the image has a resolution of 2.5 kilometres×2.5 kilometres approximately, and comprises 500×500 pixels (which corresponds to an area of 1250 km×1250 km). The clouds appear as blurry, white areas, while the sea is the dark background. The image on the right shows the associated singularity exponents, represented with a palette that assigns the brightest colours to the lowest values. It took approximately 10 seconds to obtain said singularity exponents on a laptop computer with two Centrino processors at 1.8 Mhz (the times of the other examples refer to the same computer). In addition to a richer structure associated to the clouds and atmospheric flows, the existence of concentric oceanic fronts of up to 500 km long was revealed, probably internal waves, in the centre of the image. We now know that having good knowledge of internal oceanic waves is key to understanding processes of dissipation of energy and mixture (of nutrients, spread of contaminants, etc) in oceans; despite this, there is very little, and not very systematic information regarding the areas of the planet affected by these waves. For example, those mentioned in the image on the right, despite their enormous extension (various fronts of up to 500 km long separated by up to 300 km) had not been published to date.

In FIG. 2 the top part shows an image of algae proliferation in lake Mendota (Switzerland) in false colour, as a combination of various channels in order to increase the contrast of said algae proliferation. The bottom part of the figure shows the singularity exponents, which were obtained following barely 3 seconds of calculation, represented using a palette of shades of grey in which the lower values are brightest.

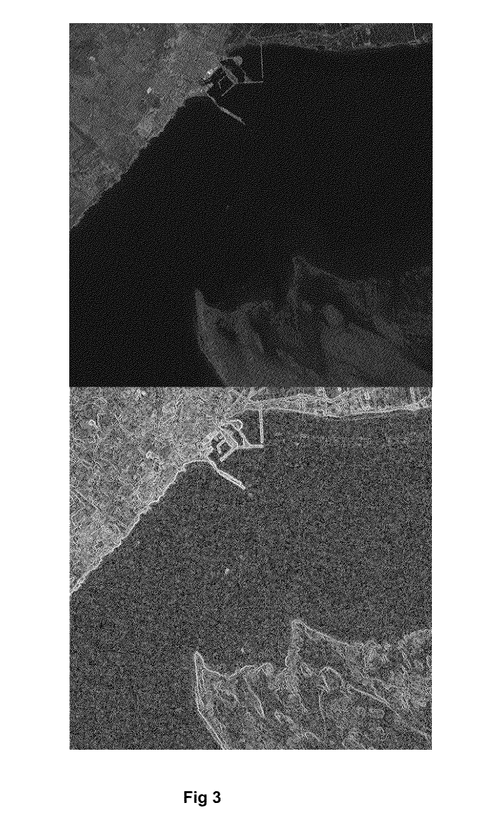

In FIG. 3 the top part shows a view of Alfacs Bay (NE Spain, River Ebro Delta) registered by band 8 of LandSat, on an unspecified date. The resolution of this image is 2.5 metres, and the represented zone covers 500×500 pixels. The bottom part of the figure shows the singularity exponents (calculation time: 10 seconds). Several boats that are barely visible in the top image appear with well-defined contours in the bottom image; various wave fronts can also be observed.

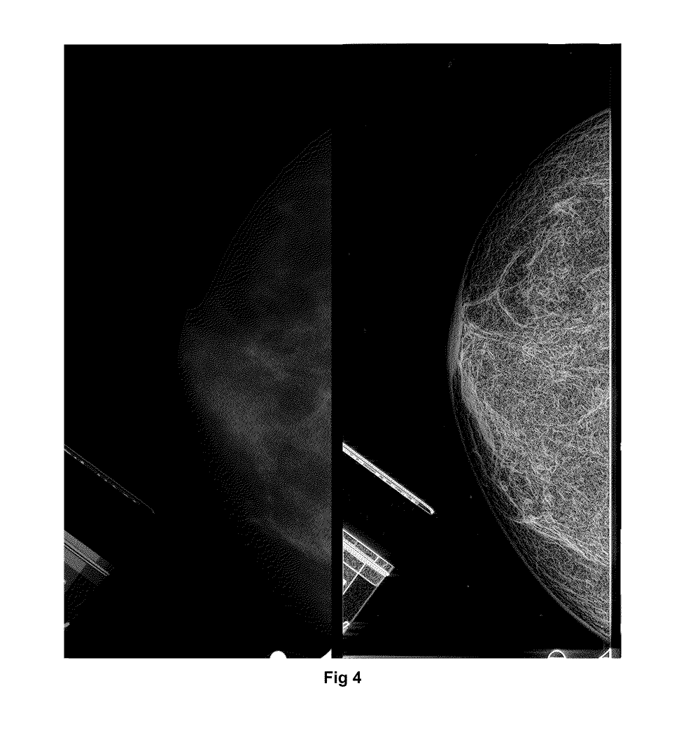

FIG. 4 on the left shows a mammography in digital format with a resolution of 1976×4312 pixels, extracted from a public archive of digital format breast scans (USF Digital Mammography Home Page, http://marathon.csee.usf.edu/Mammography/Database.html) accessed on 10 Oct. 2008. The right hand side of the same figure shows the associated singularity exponents (calculation time: approximately 4 minutes). The analysis reveals the structures of the various tissues forming the breast. This analysis could allow an earlier detection of damage. At the same time, the capacity to detect singularity lines irrespective of the contrast makes it possible to reduce the exposure to X-rays required for the detection of patterns.

In FIG. 5 the top part shows an image of 200×200 pixels of the nucleus of an onion cell in interphase, obtained through optical microscopy (image courtesy of Elisenda Gendra and Mónica Pons, Molecular Biology Institute of Barcelona, Higher Council of Scientific Research). This image was acquired from a Leica SP1 confocal microscope, in transmission mode (Nomarski), with argon laser lighting at a 488 nm wavelength. The bottom part of the same figure shows the associated singularity exponents (calculation time: approximately two seconds). The analysis of singularities reveals the existence of coherent lines inside the nucleus and on its periphery, possibly associated to structures related to elements of the nucleus such as chromatin and the nuclear membrane, such structures being difficult or impossible to resolve or reveal using optical media, in particular in the absence of any form of staining or marking. The singularity exponents appear to reveal for example the double membrane structure of the nucleus peripherally, and also structures associated to the chromatin fibres that fill the nucleus.

### Example 2

### Image Compression and Denoising

Due to the reconstruction formula, it is possible to regenerate an image based on the set of most singular points with enormous quality. Said set tends to be fairly disperse, constituting 20-30% of the total points. In order to complete the description, the gradient over said points must be recorded and stored, and coded in a compact manner. It has been observed that the gradients change smoothly over the lines of most singular manifold MSM and it is considered viable to be able to encode them in a compact manner. Therefore, reconstruction of images based on the most singular manifold MSM has been proven to have the potential to provide compression codes for high quality images.

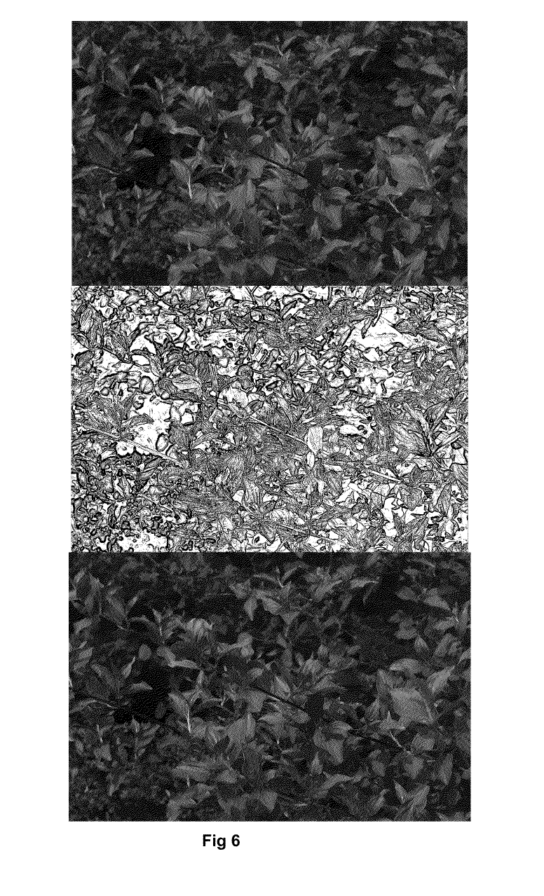

In FIG. 6, the top part shows an image of van Hateren identified in reference [18] as imk01020.imc. This image has been obtained using a CCD camera with a focal distance of 28 mm and is defined by a matrix of 1536×1024 pixels; the data is encoded as shades of grey in 12 nominal bits. It took about 50 seconds to obtain the singularity exponents. The middle part of the figure shows 30% of the most singular points. In the bottom part, the image has been reconstructed on the basis of the gradients over the MSM shown in the middle part, obtaining a quality measured using the Peak Signal-to-Noise Ratio (PSNR) of 37 dB, which indicates high quality.

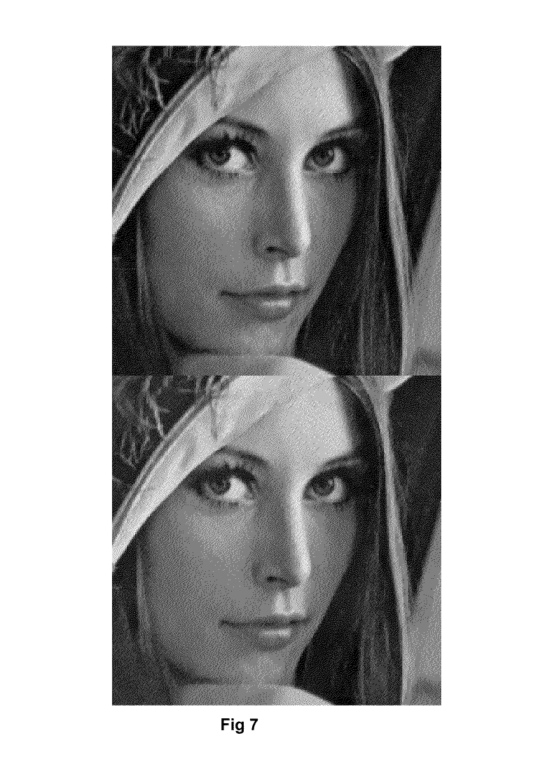

FIG. 7 shows how reconstruction through MSM makes it possible to reduce the noise present in the signal. The top part of the drawing shows the original image (image of Lena, IEEE standard in image processing) with a resolution of 200×200 pixels; the bottom part, the reconstruction based on the associated MSM. The contours and borders contained in the MSM are preserved in the reconstruction, but the transitions associated to noise, which do not form coherent fronts, are mostly eliminated, which is particularly noticeable in some areas of the face, in the reconstructed image.

### Example 3

### Determination of Flow Lines in Geophysical and Other Types of Images

Given the theoretical roots on which the definition of singularity exponents is founded, the latter are very useful when used to analyse images of scalar variables in turbulent flows. The theory predicts that singularities are advected (in other words, carried by the fluid), which can be used in order to trace current lines. In essence, the path of currents can be followed simply by analysing the images associated to temperature, chlorophyll concentration and other similar indicators. The results of the singularities derived from sea surface temperature detected by microwave sensors (MW SST) on board satellites Modis Acqua and TRMM are compared with altimeter maps.

Altimeter data is very difficult to produce and has a very poor spatial resolution, requiring filtration using a low step filter. Additionally, to produce quality altimeter maps, various active altimeters need to be combined, but since 2003 only two satellites remain in operation, and soon only one of them will be active, or even none. However, MW SST is much cheaper, can be synoptically obtained over large zones and is easy to process. As shown in the comparison, the singularities outline circulation patterns fairly well, demonstrating that they are channelled by the flow. Therefore, determining currents using singularities analysis emerges strongly as an interesting alternative for operational oceanographic systems for the management of environmental risk.

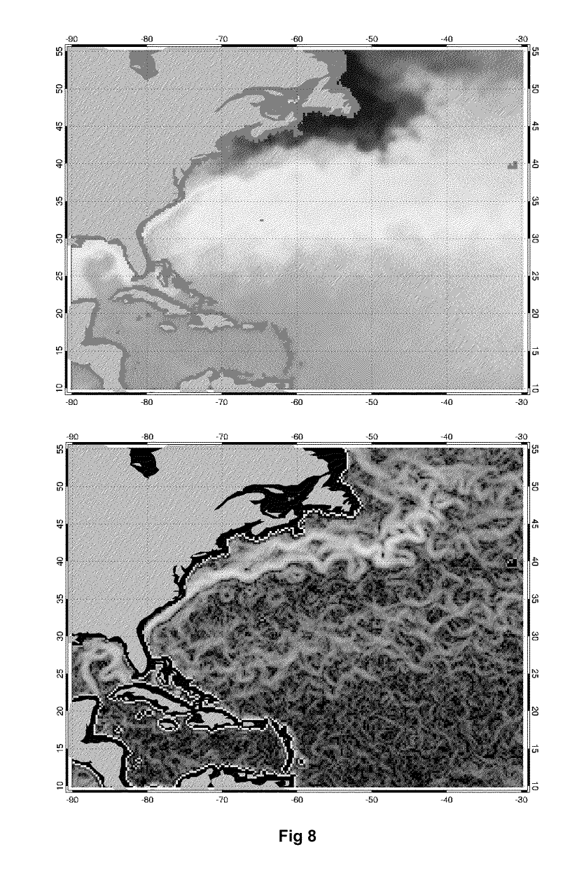

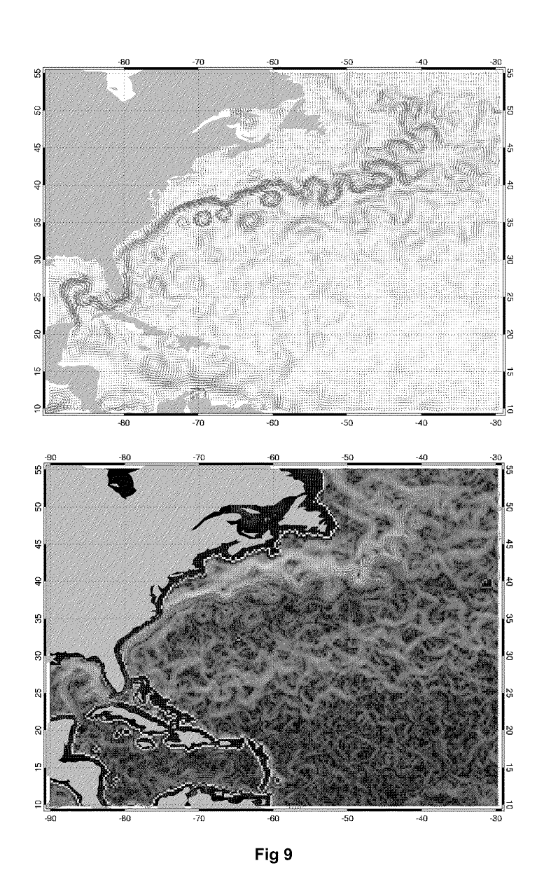

FIG. 8 shows on the bottom part the singularity exponents derived from an image of sea surface temperature obtained from microwaves (MW SST)-AMSR-E-TMI shown in the upper part, corresponding to 1 Feb. 2003 (image downloaded from Remote Sensing Systems, http://www.ssmi.com/; calculation time for the analysis of singularities: about 5 seconds). The zone shown corresponds to the current in the Gulf of Mexico. The temperature map is given on a cylindrical projection grid with a constant angular resolution of ¼ degree. The top of FIG. 9 shows the field of geostrophic currents obtained by interpolation of four altimeter satellites, for the same date of 1 Feb. 2003; the bottom part of the figure shows the overlap of the two fields (the singularity exponents of temperature of the previous figure and the geostrophic speed field of the upper panel of this figure).

### Example 4

### Dynamic Analysis of Variable Sequences in Turbulent Flows

Nowadays, the numerical simulation of fluids is an essential tool in tasks such as weather and oceanographic forecasting, the aerodynamic prototyping of models or various problems of analysis of chemical and combustion reactions, of industrial interest. However, given the chaotic nature of fluids in a turbulent regime it is not possible to make an accurate description limited by a finite number of degrees of freedom such as those imposed by the discretised grids used in numerical simulation. This problem is a consequence of the fact that when a fluid is described using a specific size of grid step the movements which take place on smaller scales cannot be resolved, which given the chaotic nature of the fluid cannot be predicted.

The usual strategy for dealing with these unresolved scales is to introduce empirical viscosity coefficients (for the speed field) and empirical diffusivity (for each variable considered in the simulation), also known as eddy viscosity and eddy diffusivity. These coefficients represent the more or less random and homogeneous dispersion of the variable considered in these unresolved scales. Said coefficients serve to model the effect of unresolved scales on resolved scales through simulation under certain circumstances; for example, if turbulence is fully developed or if the integration time of the simulation is sufficiently large compared to the typical dispersion time of unresolved scales.

Determination of the eddy viscosity and eddy diffusivity coefficients in fluids is fundamental for describing the evolution of turbulent fluids using numerical models with sufficient quality. A good determination of these coefficients is crucial in order to obtain greater accuracy for the abovementioned variables with the numerical simulation, as well as to extend the time horizon of the validity of these forecasts. However, in most numerical models used nowadays, these coefficients are taken as a constant throughout the fluid's domain. This constant is estimated in a heuristic manner for each numerical execution, although its value is usually compared with an evaluated experimental value of the dynamic sequence analysis, according to the following formula:

$${κ}_{0} = - \frac{\frac{1}{2} 〈 {\partial }_{t} {θ}_{0}^{2} 〉}{〈 {\vert ∇ {θ}_{0} \vert}^{2} 〉}$$

where κ₀ is the global empirical diffusivity coefficient, θ₀ is the analysed variable, subscript 0 refers to the scale at which processing is taking place and the triangular parentheses mean average throughout the spatial domain of the fluid. If instead of θ₀ on takes the current function, what is evaluated is viscosity, instead of diffusivity.

In reality, it is possible to pass from a global estimation of diffusivity as discussed above to a local estimation of this coefficient for each point of the domain. To do this, the averages of time derivatives and gradients of the expression above are replaced with weighted averages with a decreasing weight with the distance from the point of evaluation. However, if the global evaluation formula presented above is already somewhat unstable, the local formula is extremely unstable, giving rise to negative local diffusivity values at certain points, which is physically unacceptable. Application of the method of this invention makes it possible to obtain a more stable variable (the density of the MSM), on the basis of which very stable evaluations of global diffusivity are obtained and evaluations of local diffusivity that are not negative at any point.

As an example, local diffusivities have been evaluated using images of a colouring agent dispersed in a laboratory experiment. The top row of FIG. 10 shows a colouring agent dispersed in a 2D turbulent medium in a laboratory at two moments in time, t=0 s for the column on the left and t=10 s for the column on the right. (Images of the top row, courtesy of Patrick Tabeling, École Normale Supérieure, Paris). In the middle row of the same figure, the evaluation of local eddy diffusivity is shown for all points at the same moments as the images of the top row, using as variable θ₀ the concentration of colouring agent, which is estimated on the basis of the shade of grey of the figures of said top row. The values of local diffusivity thereby obtained have been represented using a palette of two extreme colours (red for negatives, blue for negatives), with an intermediate colour (white) for values close to zero. In order to facilitate comprehension of the figure a shaded area of thick slanted lines has been overlaid on the zones with the largest size negative values, and a shaded area in a thinner horizontal line on the zones with highest positive values. As these middle row images show, the estimation of diffusivity based on concentration gives rise to extensive areas with negative values; plus, when this sequence is processed one can see that the determination is very unstable, since the estimated values of local diffusivity in certain areas change suddenly at specific moments in time. Finally, the bottom row presents the local diffusivity evaluations for the same two moments in time obtained based on the density function of the MSM, which is calculated on the basis of the singularity exponents evaluated using this invention. As the figure shows, these evaluations of local diffusivity do not present regions with negative values; also, observation of the entire sequence shows a gentle and continuous evolution of the local diffusivity values across all points.

Next, a series of references to scientific publications on the state of the art are included, which reflect aspects explained in this invention.

### REFERENCES

[1] A. Arneodo. Wavelet analysis of fractals: from the mathematical concepts to experimental reality. In G. Erlebacher, M. Yousuff Hussaini, and L. M. Jameson, editors, Wavelets. Theory and applications, page 349. Oxford University Press. ICASE/LaRC Series in Computational Science and Engineering, Oxford, 1996.
[2] A. Arneodo, F. Argoul, E. Bacry, J. Elezgaray, and J. F. Muzy. Ondelettes, multifractales et turbulence. Diderot Editeur, Paris, France, 1995.
[3] U. Frisch. Turbulence. Cambridge Univ. Press, Cambridge Mass., 1995.
[4] S. Mallat. A theory for multiresolution signal decomposition: the wavelet representation. IEEE Transaction on Pattern Analysis and Machine Intelligence, 11:67-93, 1989.
[5] S. Mallat and W. L. Huang. Singularity detection and processing with wavelets. IEEE Trans. in Inf. Th., 38:617-643, 1992.
[6] S. Mallat and S. Zhong. Wavelet transform maxima and multiscale edges. In Ruskai M. B. et al, editor, Wavelets and their applications. Jones and Bartlett, Boston, 1991.
[7] D. Marr. Vision. Freeman and Co. Nueva York, 1982.
[8] G. Parisi and U. Frisch. On the singularity structure of fully developed turbulence. In M. Ghil, R. Benzi, and G. Parisi, editors, Turbulence and Predictability in Geophysical Fluid Dynamics. Proc. Intl. School of Physics E. Fermi, pages 84-87, Amsterdam, 1985. North Holland.
[9] O. Pont, A. Turiel, and C. Perez-Vicente. Application of the microcanonical multifractal formalism to monofractal systems. Physical Review E, 74:061110, 2006.
[10] Z. R. Struzik. Determining local singularity strengths and their spectra with the wavelet transform. Fractals, 8(2):163-179, June 2000.
[11] A. Turiel. Relevance of multifractal textures in static images. Electronic Letters on Computer Vision and Image Analysis, 1(1):35-49, 2003.
[12] A. Turiel and A. del Pozo. Reconstructing images from their most singular fractal manifold. IEEE Trans. Im. Proc., 11:345-350, 2002.
[13] A. Turiel, J. Isern-Fontanet, E. Garcia-Ladona, and J. Young. Detection of wave fronts in the Indian Ocean from geostationary sunglint satellite imagery. Próxima aparición en el International Journal of Remote Sensing, 2007.
[14] A. Turiel and N. Parga. The multi-fractal structure of contrast changes in natural images: from sharp edges to textures. Neural Computation, 12:763-793, 2000.
[15] A. Turiel and C. Perez-Vicente. Multifractal geometry in stock market time series. Physica A, 322:629-649, May 2003.
[16] A. Turiel and C. Perez-Vicente. Role of multifractal sources in the analysis of stock market time series. Physica A, 355:475-496, September 2005.
[17] A. Turiel, C. Perez-Vicente, and J. Grazzini. Numerical methods for the estimation of multifractal singularity spectra on sampled data: a comparative study. Journal of Computational Physics, 216(1):362-390, July 2006.
[18] J. H. van Hateren and A. van der Schaaf. Independent component filters of natural images compared with simple cells in primary visual cortex. Proc. R. Soc. Lond., B265:359-366, 1998.

1. Method for the analysis of singularities in digital signals, wherein it comprises the following stages:
a) determining for each point x of the signal an environment of first neighbours or local environment; and
b) calculating for each point x of the signal a reconstructibility measurement, or singularity measurement, based on the associated local environment, constructed from inference of the value of the signal at said point on the basis of the value of the points of said local environment using the following reconstruction formula
s(x)=(\vec{g}· [symbol] )(x)
where:
s is a given signal, [symbol]
is the most singular manifold or MSM of said signal s, [symbol]
is the essential gradient of s,
\vec{g} is the universal reconstruction kernel, and
symbol • means convolution scalar product
said reconstruction formula being adapted to the abovementioned environment, in such a way that the singularity measurement contains the difference between the measured value and the value inferred from the reconstruction formula.

2. Method according to claim 1, wherein it also includes a third stage c) which comprises carrying out at least one logarithmic transformation on said singularity measurement, which suppresses the dependency of the measurement on the number of points of the signal, obtaining a singularity exponent for each point of the signal.

3. Method according to claim 2, wherein it comprises, before carrying out stage a), obtaining a stable derivative function of said digital signal that is sampled at regular intervals, and in that in stage b) it comprises obtaining for each point of said sampled digital signal a singularity measurement of the function at that point, weighting the contributions of a local environment of the point and the value of the derivative at all points of said local environment.

4. Method according to claim 3, wherein the stable derivative of the digital signal which precedes stage a) is obtained by derivative of one point increases to the right or centred half point increases, the derivative being defined in both cases in the Fourier space by multiplication of the signal by the corresponding derivative cores, where assuming that there are Nₓ points in a coordinate direction x to be derived, the derivative cores are expressed as follows:
Difference of one point to the right:
$${( {{\partial }^{⋒}}_{x} )}_{n} = ( {e}^{2 π i \frac{n}{{N}_{x}}} - 1 )$$
Difference of half point centred:
$${( {{\partial }^{⋒}}_{x} )}_{n} = \{ \begin{matrix}i sin ( π \frac{n}{{N}_{x}} ) ; & n < {N}_{x} / 2 \\ - i sin ( π \frac{{N}_{x} - n}{{N}_{x}} ) ; & n \geq {N}_{x} / 2\end{matrix}$$
comprising the following stages:
application of the Fourier transform to said signal;
multiplication of a copy of the Fourier transform of the signal by the core associated to each one of the d components; and
application of the anti-transform to these d components.

5. Method according to claim 2, wherein the logarithmic transformation of stage c) which is at least one, is carried out as follows:
for each point of the sampled digital signal the measurement obtained in stage b) is taken and divided by the mean of the measurements of all points; and
the logarithm of the result is divided by the logarithm of the minimum scale of the sampled digital signal, which is defined as the d-nth root of the total number of points of the signal, where d is the dimension or number of variables inherent to the signal.

6. Method according to claim 5, wherein the singularity measurement defined in stage b) is calculated by means of the following steps:
calculating the environment vector of the (2×d) first neighbours of a base point x, obtaining the first neighbours of point x by adding consecutively to each one and only one of the coordinate indices of said point x, first −1 and then +1, forming the environment vector of (2×d)+1 components, whose first component is the value of the signal at point x, the second the value of the signal at the point obtained by adding −1 to the first coordinate of x, the third the value of the signal at the point obtained by adding +1 to the first coordinate of x, the fourth the value of the signal at the point obtained by adding −1 to the second coordinate of x, and so on successively;
extracting the tendency of this vector, which is defined as the sum of its components divided by ((2×d)−1) and applying this tendency to the environment vector, adding it to the component referring to base point x and subtracting it from the other components, in such a way that this new obtained environment vector has a zero mean;
applying a local gradient operator to said zero mean vector, which returns (2×d)+1 gradient vectors each one of them of d components, which define the local gradient:
cancelling out the components of said local gradient associated to point x;
applying to said local gradient, with the cancelled out components, a local reconstruction operator unequivocally associated to said local gradient operator obtaining a vector of (2×d)+1 components, which is referred to as an estimated signal;
applying once again the local gradient operator to said vector of (2×d)+1 components or estimated signal and obtaining (2×d)+1 vectors, one for each point of the local environment, of d components each one, which define the estimated local gradient for that environment;
obtaining (2×d)+1 vectors of d components which express the difference in gradients between said local gradient and said local estimated local gradient, and
obtaining using these (2×d)+1 vectors of difference in gradients the singularity measurement associated to point x.

7. Method according to claim 6 wherein said local gradient operator applied to the vector of (2×d)+1 components comprises, for each environment of a point x defined by the vector of (2×d)+1 components which includes the value of the signal at point x and at its (2×d) neighbours, executing a local Fourier transform, which only takes this environment into account.

8. Method according to claim 7, wherein said local Fourier transform is constructed as a matrix of ((2×d)+1))×((2×d)+1)), whose elements all have a value of 1 except those of the main diagonal and of the adjacent diagonals, where all the elements of the main diagonal excluding the first on the left, which is worth 1, are worth the complex exponential 2×π×i/3 where i is the square root of −1 and the elements of the adjacent diagonals are worth consecutively 1, exponential of −2×π×i/3, 1, and so on successively, starting from top left towards bottom right.

9. Method according to claim 8, wherein the local Fourier transform is calculated by matricially applying the described matrix of ((2×d)+1))×((2×d)+1)) to an environment vector of (2×d)+1 components.

10. Method according to claim 9, wherein the local Fourier anti-transform is calculated by applying the inverse matrix of the one described in claim 8, which always exists.

11. Method according to claim 10 wherein for each environment of a point x defined by a vector \vec{p} of (2×d)+1 components, application to \vec{p} of said local gradient operator gives a result expressed by the local gradient vector for point x and the points of its environment and comprises the following stages:
applying the local Fourier transform to \vec{p};
constructing the derivative throughout a given coordinate direction by multiplying by if i\sqrt{3} the component of the Fourier transform vector of \vec{p} associated to the point that is obtained when the coordinates of point x are modified by adding −1 to the index of said coordinate direction and by multiplying by −i\sqrt{3} the component of said same vector obtained by modifying the coordinates of point x through adding +1 to said coordinate index, and cancelling out the remaining components, thereby obtaining d derivative vectors, one for each coordinate;
applying the local Fourier anti-transform to these d vectors of (2×d)+1 components, each vector thereby representing the derivative throughout each one of the d coordinate directions at all points of the local environment; and
reordering the components of these d vectors, by grouping together for each one of the points of the local environment the d derivatives associated to that point, obtaining (2×d)+1 local gradient vectors, of d components each one, which reproduce the gradient at each point of the local environment.

12. Method according to claim 6 wherein said reconstruction operator applied to the local gradient is defined as the inverse of the local gradient operator, and comprises the following stages:
applying the local Fourier transform to the d derivative vectors throughout each coordinate direction, each one of (2×d)+1 components;
constructing the reconstruction vector throughout a given coordinate direction by dividing by i\sqrt{3} the component of the local Fourier transform vector of \vec{p} associated to the point that is obtained when the coordinates of point x are modified through adding −1 to the index of said coordinate direction and dividing by −i\sqrt{3} the component of said same vector obtained when the coordinates of point x are modified through adding +1 to said coordinate index, and cancelling out the remaining components, thereby obtaining d reconstruction vectors throughout a direction, one for each coordinate;
adding these d reconstruction vectors; and
applying the local Fourier anti-transform to the vector of (2×d)+1 components resulting from the previous step.

13. Method according to claim 6, wherein the final step of stage b) whereby the singularity measurement associated to point x is obtained comprises:
withholding from the obtained (2×d)+1 vectors of difference in gradient the d components associated to point x, and
obtaining the singularity measurement as the square root of the sum of the squares of these d components
whereby a local correlation singularity measurement is obtained suitable for measuring the unpredictability of a given point.

14. Method according to claim 6, wherein final step of stage b) whereby the singularity measurement associated to point x is obtained comprises:
taking a d-dimensional hypercube that surrounds a given point x, made up of the points obtained by adding −1, 0 or +1 to each coordinate index of x which provides 3^{d} points;
withholding for each point of said hypercube the d-dimensional vector associated to the central component (associated to the base point) of difference in gradient, and
adding these 3^{d} vectors, and calculating the scalar product of the resulting vector with the d-dimensional vector of difference in gradient associated to point x,
whereby an alignment index of differences in gradient is obtained which allows deduction of the existence of a spatial coherence between the errors committed by omitting the central point when the signal is reconstructed, allowing distinction between noise (of random orientation) and coherent signal.

15. Method according to claim 14, wherein it comprises additionally:
before carrying out stage a), obtaining a stable derivative function of said digital signal that is sampled at regular intervals, and obtaining in stage b) for each point of said sampled digital signal a singularity measurement of the function at that point, weighting as follows the contributions of a local environment of the point and the value of the derivative at all points of said local environment;
obtaining the gradient energy of the abovementioned hypercube by adding the squared modules of the gradients of each point of the hypercube;
obtaining a local correlation singularity measurement at point x by means of the following operations:
withholding from the obtained (2×d)+1 vectors of difference in gradients the d components associated to point x, and
obtaining the singularity measurement as the square root of the sum of the squares of these d components; and
obtaining the global correlation singularity measurement as the product of the local correlation singularity measurement through the square root of the absolute value of the alignment index of local differences in gradient, the latter divided by the gradient energy of the hypercube.

16. Method according to claim 15, wherein the stable derivative of the digital signal that precedes stage a) is obtained by derivative of one point increases to the right or centred half-point increases, in both cases the derivative being defined in the Fourier space by multiplication of the signal by the corresponding derivative cores, where assuming that there are Nₓ points in a coordinate direction x where said derivative cores are to be derived, the derivative cores are expressed as follows:
Difference of one point to the right:
$${( {{\partial }^{⋒}}_{x} )}_{n} = ( {e}^{2 π i \frac{n}{{N}_{x}}} - 1 )$$
Difference of half-point centred:
$${( {{\partial }^{⋒}}_{x} )}_{n} = \{ \begin{matrix}i sin ( π \frac{n}{{N}_{x}} ) ; & n < {N}_{x} / 2 \\ - i sin ( π \frac{{N}_{x} - n}{{N}_{x}} ) ; & n \geq {N}_{x} / 2\end{matrix}$$
comprising the following stages:
application of the Fourier transform to said signal;
multiplication of a copy of the Fourier transform of the signal by the core associated to each one of the d components; and
application of the anti-transform to these d components

17. Method according to claim 6, wherein said sampled digital signal is representative of:
time series, transects of physical variables selected from a group comprising, by way of illustration and not limitation, temperature, concentration of chemical species, electrical intensities, strength, pressure, and density, in the case of d=1;
images of real environments, which comprises by way of illustration and not limitation, photographic images, biomedical images (such as ultrasound scans, X-rays and radiodiagnosis and nuclear medicine images in general, such as gamma graphs, CAT, PET, MRI, and images obtained by means of any other technique), microscopic images (optical, electronic and of any other type), geophysical images, images obtained from satellites or craft conveyed by air, land, submerged or of any other type, distributed variables captured in two dimensions by sensors in land, sea, air, satellite and other media in the case of d=2;
image time sequences and two-dimensional variables of the preceding cases in three-dimensional volumes in the case of d=3;
time sequences of variables in volume in the case of d=4; or
in any number of dimensions, results of numerical simulations and synthesised signals.

18. Method according to claim 6, wherein the sampled digital signal in question is representative of a variable in a turbulent fluid, and in that it comprises obtaining the singularity exponents for the stabilisation of said variable in order to carry out a dynamic analysis of the fluid, obtaining new magnitudes such as the eddy diffusivity of the variable, the eddy viscosity of the fluid and other representative magnitudes of the fluid's unresolved scales.

19. System for the analysis of singularities in digital signals, wherein it comprises:
means for obtaining for each point of the signal a local environment that comprises the first neighbours; and
means for calculating for each point x of the signal a reconstructibility measurement, or singularity measurement based on the associated local environment, constructed from inference of the value of the signal at said point on the basis of the value of the points of said local environment using the following reconstruction formula)
s(x)=(\vec{g}· [symbol] )(x)
where:
s is a given signal, [symbol]
is the most singular manifold or MSM of said signal s, [symbol]
is the essential gradient of s,
\vec{g} is the universal reconstruction kernel, and
symbol • means convolution scalar product,
said singularity measurement containing the difference between the measured value and the value inferred for each point.

20. System according to claim 19 wherein it includes also means for carrying out at least one logarithmic transformation on said reconstructibility measurement that suppresses the dependency on the number of points of the signal, which provides a singularity exponent for each point of the signal.

21. System according to claim 20, wherein it comprises additionally:
means for obtaining a stable derivative function of the digital signal, sampled at regular intervals; and
means for obtaining for each point of said sampled digital signal a singularity measurement of the signal at that point, weighting the contributions of said local environment of the point and the value of said stable derivative at all points of said local environment.
